(19) United States
(12) Patent Application Publication
(10) Pub. No.: US 2017/0221328 A1
(43) Pub. Date: Aug. 3, 2017

(54) ABNORMAL STATUS MONITORING SYSTEM

(71) Applicant: Chuan-Wei Wang, New Taipei (TW)

(72) Inventor: Chuan-Wei Wang, New Taipei (TW)

(73) Assignee: Motionstek Incorporation, New Taipei (TW)

(21) Appl. No.: 15/421,139

(22) Filed: Jan. 31, 2017

(30) Foreign Application Priority Data
Feb. 2, 2016 (CN) 201610072107.6

(51) Int. Cl. G08B 13/16; H04L 12/58; G08B 21/18; H04B 17/318; G08B 7/06

(52) U.S. Cl. CPC G08B 13/16; H04B 17/318; G08B 7/06; G08B 21/182; H04L 51/04

(57) ABSTRACT

An abnormal status monitoring system includes a monitored side and a monitoring side. The monitored side includes a first status sensing unit for generating status information of the monitored side and a signal transmission unit for transmitting a wireless signal which includes the status information of the monitored side. The monitoring side includes a second status sensing unit for generating status information of the monitoring side, a signal receiving unit for receiving the wireless signal, and a control unit. When the received signal strength index of the wireless signal is higher than a first threshold value, the control unit compares the status information of the monitored side and the status information of the monitoring side. When a difference between the status information of the monitored side and the status information of the monitoring side is larger than a second threshold value, the control unit generates an alarm.

### CROSS REFERENCE

The present invention claims priority to CN 201610072107.6, filed on Feb. 2, 2016.

### BACKGROUND OF THE INVENTION

Field of Invention

The present invention relates to an abnormal status monitoring system, in particular a monitoring system including status sensing units respectively in a monitored side and a monitoring side, which monitor and obtain status information of the monitored side and the monitoring side, to determine an abnormal status according to a comparison between the status information of the monitored side and the monitoring side.

Description of Related Art

A typical prior art anti-theft system is to monitor a restricted space by ultrasonic waves or infrared rays, in order to detect an abnormal behavior such as stealing. For example, an in-car anti-theft system is designed in this way. When an intruder is sensed, the in-car anti-theft system can generate an alarm. This kind of anti-theft technique can be used to sense an unexpected object in a restricted space. However, such anti-theft technique is not applicable to monitoring an open space such as a public place which is crowded with people. For example, such anti-theft technique is incapable of sensing outdoor pickpockets or shoplifters in marketplaces, train stations, etc., nor is it capable of tracking stolen items.

Another kind of anti-theft technique which is typically used in stores, is to dispose a detection device at an entrance/exit of the stores, and attach a corresponding signal transmission device on each of the goods. When the detection device senses a signal from the signal transmission device, an alarm is generated to indicate a possible shoplifting behavior. If an item is purchased and the price is duly paid, the signal transmission device needs to be removed from the item. However, such anti-theft technique is not applicable in guarding personal articles; for example, when a person travels by public transportation or is in an open space, such anti-theft technique cannot prevent a thief from stealing this person's wallet.

In view of the demerits of the prior art, the present invention provides an abnormal status monitoring system, which is capable of detecting an abnormal status such as a stealing behavior and even capable of tracking a stolen item, to remedy the demerits of the prior art.

### SUMMARY OF THE INVENTION

In one perspective, the present invention provides a abnormal status monitoring system, which includes a monitored side and a monitoring side. The monitored side includes a first status sensing unit and a signal transmission unit. The first status sensing unit is configured to operably generate status information of the monitored side. The signal transmission unit is coupled to the first status sensing unit for transmitting a wireless signal which includes the status information of the monitored side. The monitoring side includes a second status sensing unit, a signal receiving unit, and a control unit. The second status sensing unit is configured to operably generate status information of the monitoring side. The signal receiving unit is configured to operably receive the wireless signal and generate a received signal strength index (RSSI) corresponding to the wireless signal. The control unit is coupled to the second status sensing unit and the signal receiving unit for comparing the RSSI with a first threshold value. When the RSSI is higher than the first threshold value, the control unit compares the status information of the monitored side and the status information of the monitoring side, and when a difference between the status information of the monitored side and the status information of the monitoring side is larger than a second threshold value, the control unit generates an alarm.

In one embodiment, the status information of the monitored side and the monitoring side includes vibration status information, azimuth status information, altitude status information, acoustic pressure status information, or a combination of two or more of the above.

In one embodiment, the status information of the monitored side and the monitoring side includes vibration status information, and the vibration status information includes: a vibration frequency, a vibrational swing count, or an angular variation of the monitoring side or the monitored side.

In one embodiment, the status information includes azimuth status information of the monitored side or azimuth status information of the monitoring side. The control unit compares the azimuth status information of the monitored side and the azimuth status information of the monitoring side, to determine whether to generate the alarm or not.

In one embodiment, the status information includes altitude status information of the monitored side or the monitoring side. The control unit compares the altitude status information of the monitored side and the altitude status information of the monitoring side, to determine whether to generate the alarm or not.

In one embodiment, the status information includes acoustic pressure status information of the monitored side or the monitoring side. The control unit compares the acoustic pressure status information of the monitored side and the acoustic pressure status information of the monitoring side, to determine whether to generate the alarm or not.

In one embodiment, the signal receiving unit transmits the status information of the monitored side to the control unit according to the received wireless signal.

In one embodiment, the first status sensing unit includes a pedometer, or the second status sensing unit includes a pedometer.

In one embodiment, the control unit includes an alarm generator for generating the alarm. When the difference between the status information of the monitored side and the status information of the monitoring side is larger than the second threshold value, the control unit generates the alarm which includes: warning sound, vibration, light, image, message sent to email address, message sent to local network, message sent to internet terminal, message sent to internet website, or a combination of two or more of the above.

In one embodiment, the monitoring side is located in or on a portable device, or kept or carried by a user.

In one embodiment, the abnormal status monitoring system is further configured to operably monitor a device under monitor, wherein the monitored side is located in or on the device under monitor. In one embodiment, the device under monitor is an important item or a valuable article.

In one perspective, the present invention provides a abnormal status monitoring system, which includes a monitored side and a monitoring side. The monitored side includes a first status sensing unit and a signal transmission unit. The first status sensing unit is configured to operably generate status information of the monitored side, wherein the status information includes vibration status information of the monitored side. The signal transmission unit is coupled to the first status sensing unit to transmit a wireless signal which includes the status information of the monitored side. The monitoring side includes a second status sensing unit, a signal receiving unit, and a control unit. The second status sensing unit is configured to operably generate status information of the monitoring side, wherein the status information includes vibration status information of the monitoring side. The signal receiving unit is configured to operably receive the wireless signal and retrieve the status information of the monitored side in the wireless signal. The control unit is coupled to the second status sensing unit and the signal receiving unit for comparing the status information of the monitoring side and the status information of the monitored side, wherein when a difference between the status information of the monitoring side and the monitored side is larger than a threshold value, the control unit generates an alarm.

The objectives, technical details, features, and effects of the present invention will be better understood with regard to the detailed description of the embodiments below, with reference to the drawings.

### BRIEF DESCRIPTION OF THE DRAWINGS

FIGS. 1 and 2 show abnormal status monitoring systems according to two embodiments of the present invention.

FIGS. 3 and 4 show control units according to two embodiments of the present invention.

### DESCRIPTION OF THE PREFERRED EMBODIMENTS

The drawings as referred to throughout the description of the present invention are for illustrative purpose only, o show the interrelations between the components, but not drawn according to actual scale.

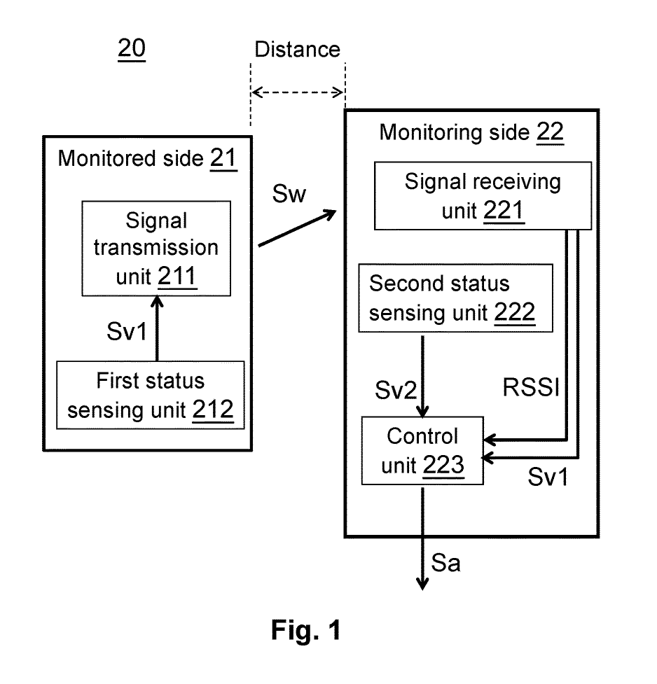

FIG. 1 shows an abnormal status monitoring systems 20 according to one perspective of the present invention. The abnormal status monitoring system 20 includes a monitored side 21 and a monitoring side 22, wherein the monitored side 21 and the monitoring side 22 are separately located in different places (i.e., there is a distance between the monitored side and the monitoring side 22). In one embodiment, the monitored side 21 is attached to or located in a device under monitor, such as a wallet, an important document, a luggage, an electronic product, a jewelry, a high-quality clothing, a watch, etc. The monitored side 21 for example can be made as, but not limited to, an adhesive label, a padlock, an ornament, etc., which can be placed on or in the device under monitor by sticking, locking, attaching, tying or any suitable ways.

In one embodiment, the monitoring side 22 is a portable device, or the monitoring side 22 is provided in a portable device, or the monitoring side 22 is kept by a user such as around his wrist, neck or in his pocket, etc. The outer shape of the monitoring side 22 can be designed according to how it is to be kept by the user. The portable device for example can be, but is not limited to, a mobile phone, a tablet computer, a smart bracelet, etc.

The monitored side 21 includes a signal transmission unit 211 and a first status sensing unit 212. The first status sensing unit 212 is configured to operably generate status information Sv1 by sensing a status of the monitored side 21. The signal transmission unit 211 is coupled to the first status sensing unit 212 for transmitting a wireless signal Sw which includes or indicates the status information Sv1 of the monitored side 21. In one embodiment, the first status sensing unit 212 can be a vibration sensing unit, for sensing the vibration of the monitored side 21 to generate the status information Sv1 which includes or indicates the vibration status information of the monitored side 21. In other embodiments of the present invention, the first status sensing unit 212 can be other types of sensing units (more examples are explained later).

The monitoring side 22 includes a signal receiving unit 221, a second status sensing unit 222, and a control unit 223. The second status sensing unit 222 is configured to operably generate status information of the monitoring side 22. The signal receiving unit 221 is configured to operably receive the wireless signal Sw and generate a received signal strength index (RSSI) corresponding to the wireless signal SW. The control unit 223 is coupled to the second status sensing unit 222 and the signal receiving unit 221. The control unit 223 compares the received signal strength index RSSI with a first threshold value. When the received signal strength index RSSI is higher than the first threshold value, the control unit 223 compares the status information Sv1 of the monitored side 21 and the status information Sv2 of monitoring side 22; when a difference between the status information Sv1 of the monitored side 21 and the status information Sv2 of monitoring side 22 is larger than a second threshold value, the control unit 223 generates an alarm Sa. In one embodiment, the second status sensing unit 222 can be a vibration sensing unit, for for sensing the vibration of the monitoring side 22 to generate the status information Sv2 which includes or indicates the vibration status information of the monitoring side 22. In other embodiments of the present invention, the second status sensing unit 222 can be other types of sensing units (more examples are explained later).

On one hand, the received signal strength index RSSI of the wireless signal Sw is related to a transmission distance of the wireless signal Sw, wherein the received signal strength index RSSI changes in correspondence to a longer transmission distance of the wireless signal Sw. In one embodiment, when the monitored side 21 and monitoring side 22 are very close to each other, the received signal strength index RSSI is −25 dB; when the distance between the monitored side 21 and monitoring side 22 is 10 meters, the received signal strength index RSSI is −10 dB. Therefore, when receive the wireless signal Sw receives the signal receiving unit 221, a corresponding received signal strength index RSSI which is related to the transmission distance of the wireless signal Sw can be obtained. When the received signal strength index RSSI of the wireless signal Sw received by the control unit 223 is higher than a threshold (the first threshold value), it means that the distance between the monitored side 21 and the monitoring side 22 is longer than a certain predetermined distance range; this implies that the monitored side 21 may be stolen (i.e., the device under monitor which contains the monitored side 21 may be stolen). On the other hand, the received signal strength index RSSI of the wireless signal Sw is also related to the shielding condition (“shielding” means blocking wireless communication) between the monitored side 21 and the monitoring side 22. Normally, there should be no particular shielding between the monitored side 21 and the monitoring side 22. Therefore, when the received signal strength index RSSI of the wireless signal Sw is influenced by a shielding situation between the monitored side 21 and the monitoring side 22, it also implies that the monitored side 21 could be stolen.

However, if the control unit 223 determines whether the monitored side 21 is stolen only according to the received signal strength index RSSI, the control unit 223 might misjudge and generate a false alarm which may cause a trouble. For example, the received signal strength index RSSI might temporarily increase due to a temporary transmission shielding condition or an environmental noise. Therefore, in one embodiment, the control unit 223 determines whether to generate the alarm Sa, not only according to the received signal strength index RSSI, but also according to the status information Sv1 of the monitored side 21 and the status information Sv2 of the monitoring side 22 (which indicate the statuses of the monitored side 21 and the monitoring side 22, which are the vibration statuses in one embodiment).

More specifically: when the received signal strength index RSSI is higher than the first threshold value (the unit of the received signal strength index RSSI is −dB, which is a negative number so the term “higher” is used to indicate a comparison result between negative numbers. From the standpoint of “absolute value”, a higher negative number is lower in absolute value), it indicates that the distance between the monitored side 21 and the monitoring side 22 is longer than a predetermined distance range, or an improper shielding condition occurs between the monitored side 21 and the monitoring side 22, both of which imply that the monitored side 21 and the device under monitor may be stolen). Under such circumstance, a confirmation check is performed by the control unit 223. The control unit 223 checks whether the difference between the status information Sv1 of the monitored side 21 and the status information Sv2 of the monitoring side 22 is larger than a second threshold value. When the difference between the status information Sv1 and the status information Sv2 is larger than the second threshold value, it means that the monitored side 21 and the monitoring side 22 have different motion statuses (for example, different vibration statuses if the status information Sv1 and Sv2 are related to vibrations). That is, when the difference between the status information Sv1 and the status information Sv2 is larger than the second threshold value, it strong implies that at least one of the monitored side 21 and the monitoring side 22 is not on the user, so the monitored side 21 is very possibly stolen, or dropped. Accordingly, the abnormal status monitoring system 20 generates the alarm Sa. Usually, after a pickpocket steals something, he needs to pass the stolen article to someone else and keep it inside a non-open storage space such as another pickpocket's bag. During such pass and storage actions, there must be certain recognizable difference occurring, between the state information Sv1 and Sv2. On the other hand, when the received signal strength index RSSI is higher than the first threshold value but the difference between the status information Sv1 and Sv2 is not very large (for example, the difference between the vibration status information of the monitored side 21 and the vibration status information of the monitoring side 22 is not higher than the second threshold value), it strongly implies that the monitored side 21 and the monitoring side 22 are both at the same location, i.e. still on the user, and the abnormal status monitoring system does not generate the alarm Sa to avoid causing any trouble.

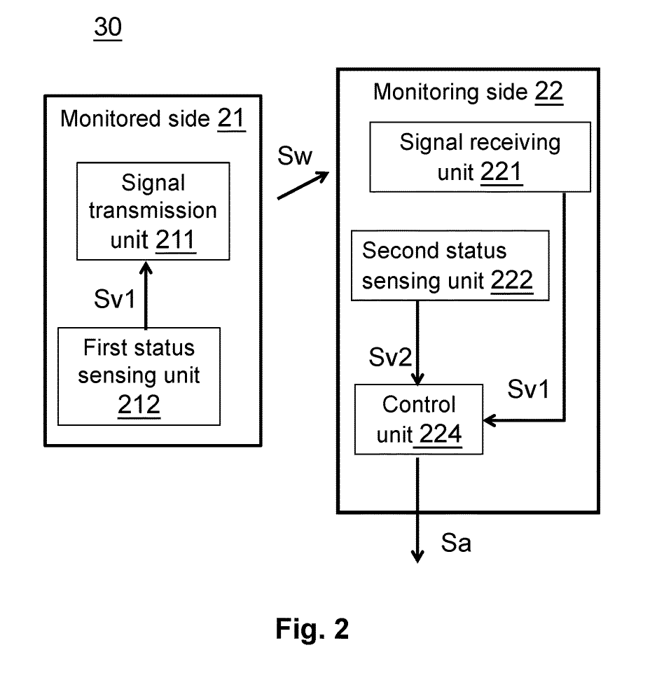

Please refer to FIG. 2, which shows the abnormal status monitoring system 30 according to another embodiment of the present invention. This embodiment shows a different way to monitor whether the monitored side 21 is stolen. In this embodiment, the abnormal status monitoring system 30 compares the status information Sv1 and Sv2 of the monitored side 21 and the monitoring side 22, to determine whether the monitored side 21 or the device under monitor is stolen or not, but does not rely on the received signal strength index RSSI. For example, when the pickpocket has stolen an article containing the monitored side 21, he might be still very close to the owner of the stolen article, so the received signal strength index RSSI may not change very much. However, one way or the other, the pickpocket has to move the stolen article and put it inside the pickpocket's certain storage space, so there must be certain recognizable difference occurring between the state information Sv1 and Sv2. Therefore, by comparing the status information Sv1 and Sv2, it can be determined as to whether the monitored side 21 or the device under monitor is stolen or not, and an alarm Sa can be generated accordingly. In one embodiment, the signal receiving unit 221 in the monitoring side 22 can receive the wireless signal Sw, and obtain the vibration status information of the monitored side 21 according to the wireless signal Sw, to generate the status information Sv1 of the monitored side 21. The control unit 224 can determine whether to generate the alarm Sa according to the status information Sv1 of the monitored side 21 and the status information of the monitoring side 22.

The aforementioned status information Sv1 of the monitored side 21 and the status information Sv2 of the monitoring side 22 correspond to the motion statuses of the monitored side 21 and the monitoring side 22, respectively. In one embodiment, the status information Sv1 and Sv2 indicate vibration frequencies. When the monitored side 21 or the monitoring side 22 moves relatively slower, the vibration frequency is lower; when the monitored side 21 or the monitoring side 22 moves faster, the vibration frequency is higher. In this example, by comparing the difference between the vibration frequencies of the monitored side 21 and the monitoring side 22 it can be determined as to whether the monitored side 21 and the monitoring side 22 are located at the same place, and hence, whether the monitored side 21 is stolen or not.

In another embodiment, the status information Sv1 of the monitored side 21 and the status information Sv2 of the monitoring side 22 include vibration swing counts. This vibration swing count can be a number count of the vibration swings in a period of time, or a number calculated by other methods. Similarly, the control unit 223 can determine whether the monitored side 21 and monitoring side 22 are at the same location or not (the latter implying the monitored side 21 being stolen) according to the difference between the vibration swing counts of the monitored side 21 and monitoring side 22.

In yet another embodiment, the status information Sv1 of the monitored side 21 and the status information Sv2 of the monitoring side 22 include angular variations. Angular variations can be regarded as one type of vibration status information. In one embodiment, “angular variation” can be defined as an accumulated count of changes in angle which are higher than a third threshold value in a period of time.

The first status sensing unit 212 or the second status sensing unit 222 for example can be, but is not limited to, a motion sensor, such as an acceleration sensor, an angular velocity sensor, pedometer, etc. Such motion sensor can be manufactured as a MEMS device. The combination of the pedometer into a portable device is a matured technique nowadays; however, the prior art never proposes to compare a vibration signal generated by the pedometer with the vibration status information of the portable device. The present invention provides an effective anti-thief function based on a matured technique, to greatly improve the function and the application of the existing products.

Besides the aforementioned embodiments, the status information of the monitored and monitoring sides can be or can include other types of status information, such as azimuth status information, altitude status information, acoustic pressure status information, or a combination of two or more kinds of status information, such as two or more of the aforementioned vibration frequencies information, the vibrational swing counts information, the angular variations information, the azimuth status information, the altitude status information, and the acoustic pressure status information, etc. The “combination” for example can be generating two or more kinds of status information in parallel or in series, and/or combing two or more kinds of status information by given arithmetic formulas (adding different status information with different weightings, for example), to generate the status information Sv1 and Sv2 of the monitored side 21 and the monitoring side 22.

In one embodiment, the status information Sv1 and Sv2 can include the azimuth status information of the monitored and monitoring sides 21 and 22. The azimuth status information can include angular information, such as an angular difference between a geographical orientation of the monitored side 21 and a predetermined orientation (or an angular difference between a geographical orientation of the monitoring side 22 and a predetermined orientation), or other kinds of angle-related-status. When the monitored side 21 and the monitoring side 22 have substantially the same angular variations (for example, when the monitored side 21 and the monitoring side 22 simultaneously turn left or simultaneously turn right), the monitored side 21 and the monitoring side 22 have substantially the same motion statuses and it implies that the monitored side 21 and the monitoring side 22 are located at the same location (very possibly both on the user). When the monitored side 21 is stolen, the angular difference between a geographical orientation of the monitored side 21 and the angular difference between a geographical orientation of the monitoring side 22 and the predetermined orientation are very possibly inconsistent. The aforementioned angular difference for example can be obtained by measuring an angle between the geomagnetic orientation and a direction of the monitored side 21 (or the monitoring side 22).

In one embodiment, the azimuth status information can be location statuses of the monitored side 21 and the monitoring side 22. These location statuses can be obtained by Global Positioning System (GPS), or can be determined according to triangulation technique (determining the position of a point by forming a triangle with it from known points). The location statuses of the monitored and monitoring sides 21 and 22 can include location variations of the monitored and monitoring sides 21 and 22, or a distance between the monitored and monitoring sides 21 and 22 which is determined according to the locations of the monitored and monitoring sides 21 and 22. When the monitored side 21 and the monitoring side 22 have similar location variations (for example, the monitored side 21 and the monitoring side 22 move simultaneously to the north, or to the east, etc.), or when the distance between the monitored side 21 and the monitoring side 22 is shorter than a predetermined distance range, it implies that the monitored side 21 and the monitoring side 22 are at the same location (very possibly both on the user). When the monitored side 21 is stolen, the location variations of the monitored side 21 and the monitoring side 22 are very possibly inconsistent, or the distance between the monitored side 21 and the monitoring side 22 is longer than the predetermined distance range.

In one embodiment, the status information of the monitored and monitoring sides 21 and 22 can include altitude status information, wherein the altitude status information can be sensed by an altimeter or a pressure sensor. For example, the altitude status information of the monitored and monitoring sides 21 and 22 can include the altitude variations of the monitored and monitoring sides 21 and 22, or, an altitude difference between the respective altitudes of the monitored and monitoring sides 21 and 22 can be calculated. For example, when the user is climbing a mountain, taking an elevator, or taking an airplane, when the altitude variations of the monitored and monitoring sides 21 and 22 are similar, or when the altitude difference between the monitored and monitoring sides 21 and 22 is shorter than a predetermined altitude range, it implies that the monitored and monitoring sides 21 and 22 are at the same location (very possibly both on the user). When the user is moving in altitude and the altitude variations of the monitored and monitoring sides 21 and 22 are inconsistent, or the altitude difference between the monitored and monitoring sides 21 and 22 is higher than the predetermined altitude range, it implies that the monitored side 21 may be stolen.

In one embodiment, the status information can include the acoustic pressure status information of the monitored and monitoring sides 21 and 22. The acoustic pressure status information can be sensed by a pressure sensor or other types of sensors. For example, the acoustic pressure status information of the monitored and monitoring sides 21 and 22 can include the acoustic pressure variations of the monitored and monitoring sides 21 and 22, or, an acoustic pressure difference between the respective acoustic pressures of the monitored and monitoring sides 21 and 22 can be calculated, to determine whether the monitored and monitoring sides 21 and 22 are at the same location. When the acoustic pressure variations of the monitored and monitoring sides 21 and 22 are similar (for example, the acoustic pressures of the monitored and the monitoring sides 21 and 22 within a certain frequency range simultaneously increase, or simultaneously decrease), or when the acoustic pressure difference between the monitored and monitoring sides 21 and 22 is lower than a predetermined acoustic pressure range, it implies that the monitored and monitoring sides 21 and 22 are at the same location. When the acoustic pressure variations of the monitored and monitoring sides 21 and 22 are inconsistent, or the acoustic pressure difference between the monitored and monitoring sides 21 and 22 is higher than the predetermined acoustic pressure range, it implies that the monitored side 21 may be stolen.

The aforementioned sensors for sensing various statuses can be manufactured by MEMS devices.

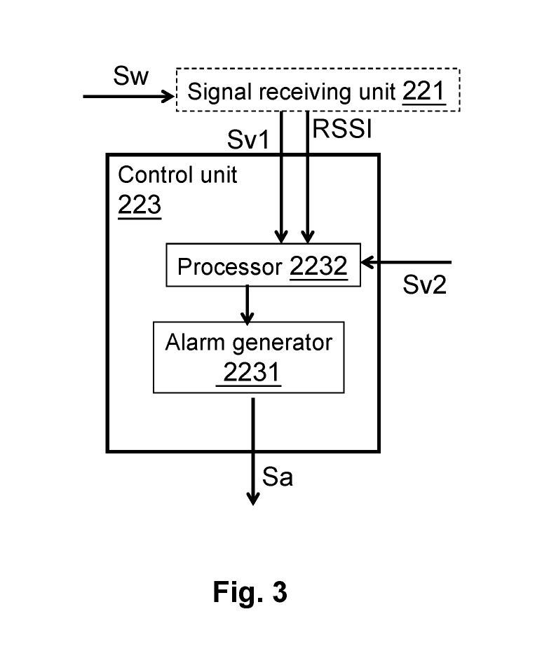

FIG. 3 shows the control unit 223 according to one embodiment of the present invention. The signal receiving unit 221 transmits the status information Sv1 of the monitored side 21 to the control unit 223 according to the received wireless signal Sw. The control unit 223 can include an alarm generator 2231 and a processor 2232. The processor 2232 receives the status information Sv2, and the status information Sv1 and the received signal strength index RSSI from the signal receiving unit 221. When the difference between the status information Sv1 and Sv2 is higher than the second threshold value, the processor 2232 controls the alarm generator 2231 to generate the alarm Sa. The alarm Sa generated by the alarm generator 2231 for example can include: warning sound, vibration, light, image, message sent to email address, message sent to local network, message sent to internet terminal, message sent to internet website, or any combination of two or more of the above.

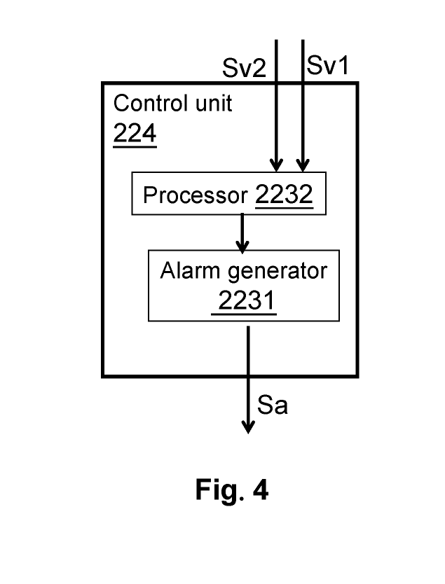

FIG. 4 shows the control unit 224 according to one embodiment of the present invention, wherein the control unit 224 includes the alarm generator 2231 and the processor 2232. The processor 2232 receives the status information Sv1 and Sv2. When the difference between the status information Sv1 and Sv2 is higher than the second threshold value, the processor 2232 controls the alarm generator 2231 to generate the alarm Sa. The alarm Sa generated by the alarm generator 2231 for example can include: warning sound, vibration, light, image, message sent to email address, message sent to local network, message sent to internet terminal, message sent to internet website, or any combination of two or more of the above.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention; for example, there may be additional devices or circuits inserted between two devices or circuits shown to be in direct connection in the embodiments, as long as such inserted devices or circuits do not affect the primary function of the circuitry. Besides, an embodiment or a claim of the present invention does not need to attain or include all the objectives, advantages or features described in the above. The abstract and the title are provided for assisting searches and not to be read as limitations to the scope of the present invention. It is not limited for each of the embodiments described hereinbefore to be used alone; under the spirit of the present invention, two or more of the embodiments described hereinbefore can be used in combination. For example, two or more of the embodiments can be used together, or, apart of one embodiment can be used to replace a corresponding part of another embodiment.

What is claimed is:

1. An abnormal status monitoring system, comprising:
a monitored side, including:
a first status sensing unit, being configured to operably generate status information of the monitored side; and
a signal transmission unit, coupled to the first status sensing unit for transmitting a wireless signal which includes the status information of the monitored side; and
a monitoring side, including:
a second status sensing unit, being configured to operably generate status information of the monitoring side;
a signal receiving unit, being configured to operably receive the wireless signal and generate a received signal strength index (RSSI) corresponding to the wireless signal; and
a control unit, coupled to the second status sensing unit and the signal receiving unit for comparing the RSSI with a first threshold value, wherein when the RSSI is higher than the first threshold value, the control unit compares the status information of the monitored side and the status information of the monitoring side, and when a difference between the status information of the monitored side and monitoring side is larger than a second threshold value, the control unit generates an alarm.

2. The abnormal status monitoring system of claim 1, wherein the status information of the monitored side and the monitoring side includes vibration status information, azimuth status information, altitude status information, acoustic pressure status information, or a combination of two or more of the above.

3. The abnormal status monitoring system of claim 1, wherein the status information of the monitored side and the monitoring side includes vibration status information, and the vibration status information includes: a vibration frequency, a vibrational swing count, or an angular variation of the monitoring side or the monitored side.

4. The abnormal status monitoring system of claim 1, wherein the signal receiving unit transmits the status information of the monitored side which is included in the received wireless signal to the control unit.

5. The abnormal status monitoring system of claim 1, wherein each of the first status sensing unit and the second status sensing unit includes a pedometer.

6. The abnormal status monitoring system of claim 1, wherein the control unit further includes an alarm generator for generating the alarm, wherein the alarm includes: warning sound, vibration, light, image, message sent to email address, message sent to local network, message sent to internet terminal, message sent to internet website, or a combination of two or more of the above.

7. The abnormal status monitoring system of claim 1, wherein the monitoring side is located in a portable device.

8. The abnormal status monitoring system of claim 1, wherein the abnormal status monitoring system is configured to operably monitor a device under monitor, and the monitored side is located in or on the device under monitor.

9. An abnormal status monitoring system, comprising:
a monitored side, including:
a first status sensing unit, being configured to operably generate status information of the monitored side, wherein the status information includes vibration status information of the monitored side; and
a signal transmission unit, coupled to the first status sensing unit for transmitting a wireless signal which includes the status information of the monitored side; and
a monitoring side, including:
a second status sensing unit, being configured to operably generate status information of the monitoring side, wherein the status information includes vibration status information of the monitoring side;
a signal receiving unit, being configured to operably receive the wireless signal and retrieve the status information of the monitored side in the wireless signal; and
a control unit, coupled to the second status sensing unit and the signal receiving unit for comparing the status information of the monitoring side and the status information of the monitored side, wherein when a difference between the status information of the monitoring side and the monitored side is larger than a threshold value, the control unit generates an alarm.

10. The abnormal status monitoring system of claim 9, wherein the vibration status information includes: a vibration frequency, a vibrational swing count, or an angular variation of the monitoring side or the monitored side.

11. The abnormal status monitoring system of claim 9, wherein the control unit further includes an alarm generator for generating the alarm, wherein the alarm includes: warning sound, vibration, light, image, message sent to email address, message sent to local network, message sent to internet terminal, message sent to internet website, or a combination of two or more of the above.
